(19) United States
(12) Patent Application Publication
(10) Pub. No.: US 2010/0315772 A1
(43) Pub. Date: Dec. 16, 2010

(54) Combination wireless computer apparatus and portable bag

(76) Inventor: Chien-Ho Ko, Changhua County (TW)

Correspondence Address: BRIAN M. MCINNIS, 12th Floor, Ruttonjee House, 11 Duddell Street, Hong Kong, HK

(21) Appl. No.: 12/068,853

(22) Filed: Feb. 12, 2008

(30) Foreign Application Priority Data
Dec. 10, 2007 (TW) 96220961

(51) Int. Cl. G06F 1/16

(52) U.S. Cl. 361/679.55

(57) ABSTRACT

A combination wireless computer apparatus and portable bag is disclosed. The combination includes a wireless computer module and a portable bag. The wireless computer module includes a computer and a radio frequency identification system electrically connected with each other wherein the computer has a body and a display. The portable bag holds the wireless computer module, and includes a bag and a first container wherein the bag has a compartment, an opening, a showing area, and multiple side slots. Thus, the wireless computer module is received in the compartment through the opening, the display is exposed through the showing area, and the radio frequency identification system is held in the first container of the portable bag.

### RELATED APPLICATIONS

This application claims priority to Taiwan Application Serial Number 96220961, filed Dec. 10, 2007, which is herein incorporated by reference.

### BACKGROUND

1. Field of Invention

The present invention relates to a wireless computer apparatus, and more particularly to a combination wireless computer apparatus and portable bag.

2. Description of Related Art

Warehouse management systems (WMS) are important operational business tools wherein radio frequency identification (RFID) has been generally applied to WMS for item classification, storage, or even track. Hence, product assembly and feeding can be controlled precisely through RFID method to reduce errors on the production line. In addition, the RFID method improves the efficiency of inventory tracking and management such that human resource costs can be decreased and human errors can also be reduced.

A conventional WMS includes a computer, a RFID system, and a touch pen whereby the operator holds the computer in one hand and the RFID system and the touch pen in the other hand so as to enter the stock through the computer system after item identification by the RFID system. In this way, it is inconvenient for the operator to select the option shown on the display of the computer with the touch pen when the computer and the RFID system are respectively held in the hands. However the machines are easily damaged if the user accidentally drops them.

As a result, solving the inconvenience during the operation of the WMS with RFID system to enhance working efficiency becomes the target of the present invention.

### SUMMARY

It is therefore an aspect to provide a combination wireless computer apparatus and portable bag to fasten the radio frequency identification system on a portable bag or user to prevent from falling down and enhance working efficiency.

In accordance with an embodiment of the present invention, the combination of a wireless computer apparatus and portable bag includes a is wireless computer module and a portable bag. The wireless computer module includes a computer and a radio frequency identification system electrically connected to each other wherein the computer has a body and a display. The portable bag holds the wireless computer module, and includes a bag and a first container wherein the bag has a compartment, an opening, a showing area, and multiple side slots. Thus, the wireless computer module is passed through the opening to be received in the compartment, the display is exposed through the showing area, and the radio frequency identification system is held in the first container of the portable bag.

In addition, the computer further has an upper lid and a joint unit wherein the upper lid covers the body to shelter the keyboard, and the joint unit is connected between the body and the upper lid, and has a first hinge and a second hinge. The first hinge provides a first orientation range whereby the upper lid is capable of being lifted from the body, and the second hinge provides a second orientation range whereby the upper lid is capable of being rotated on the body and the display of the upper lid is rotated form the first position facing the body to the second position corresponding to the showing area of the bag to reveal the display through the showing area. The joint unit is exposed through one of the side slots.

Furthermore, the bag of the portable bag includes a hook portion and a loop portion wherein the hook portion is placed on the back of the first container and the loop portion is placed on the back of the bag. The first container holding the radio frequency identification is detachably attached on the bag through the bond between the hook portion and the loop portion to provide convenient carry and prevent from falling down.

The first container further includes a hanger which can be hung around the waist to provide the same effect as that provided by the bond between the hook portion and the loop portion.

As a result, the computer and the radio frequency identification are respectively protected by the bag and the first container to prevent from being damaged by external force. In addition, the first container holding the radio frequency identification is detachably attached on the bag such that the user can make an inventory without carrying the radio frequency identification on another hand to solve the inconvenience problem and raise working efficiency.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a perspective view of a combination wireless computer apparatus and portable bag of a first embodiment in accordance with the present invention;

FIG. 2 is a rear view of the portable bag in accordance with FIG. 1;

FIG. 3 is an assembly side view of the combination of the wireless computer apparatus and the portable bag;

FIG. 4 is a perspective view of the computer in accordance with the first embodiment in FIG. 1;

FIG. 5 is an operational perspective view showing the first embodiment in FIG. 1 applied in practice; and

FIG. 6 is an operational perspective view showing a second embodiment of the combination of the wireless computer apparatus and the portable bag applied in practice.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

While the specification concludes with claims defining the features of the invention that are regarded as novel, it is believed that the invention will be better understood from a consideration of the following description in conjunction with the figures, in which like reference numerals are carried forward.

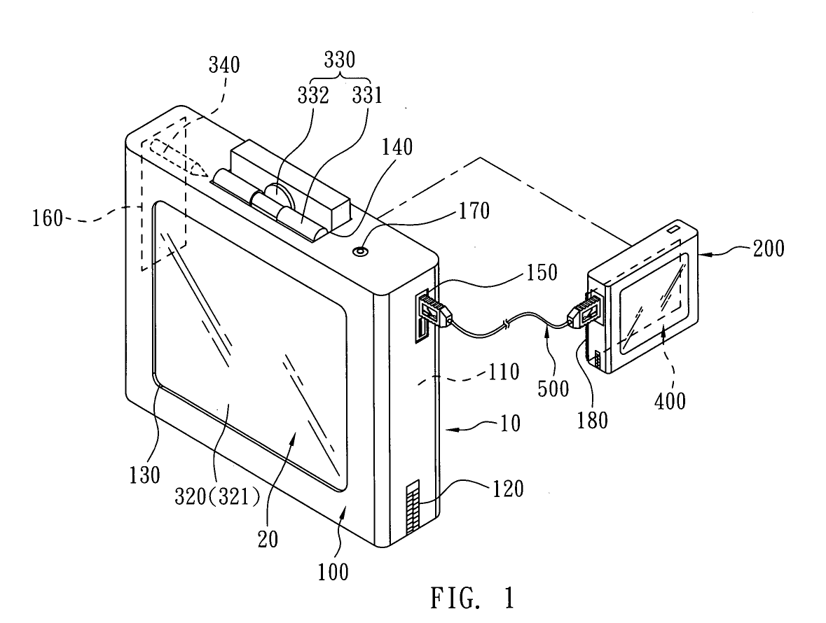

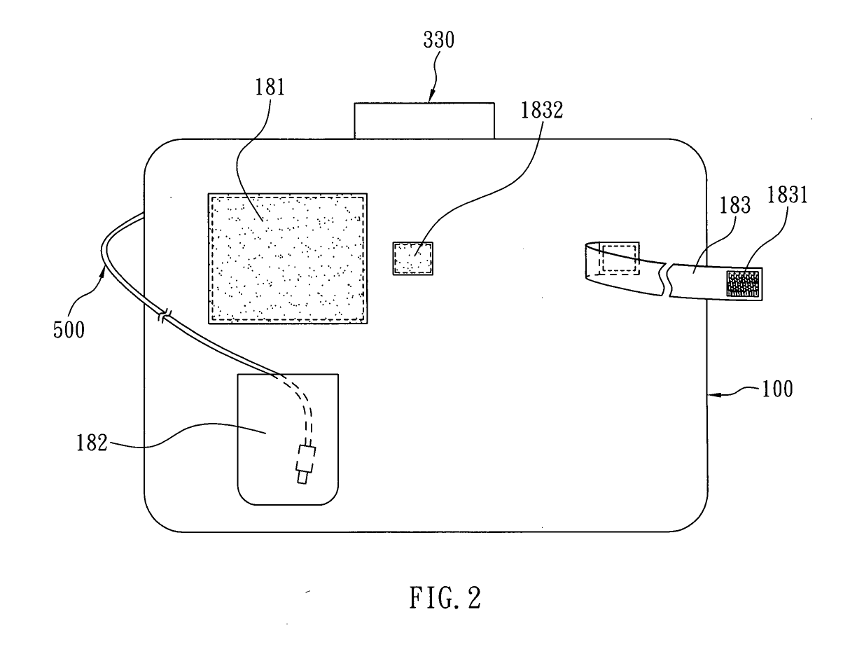

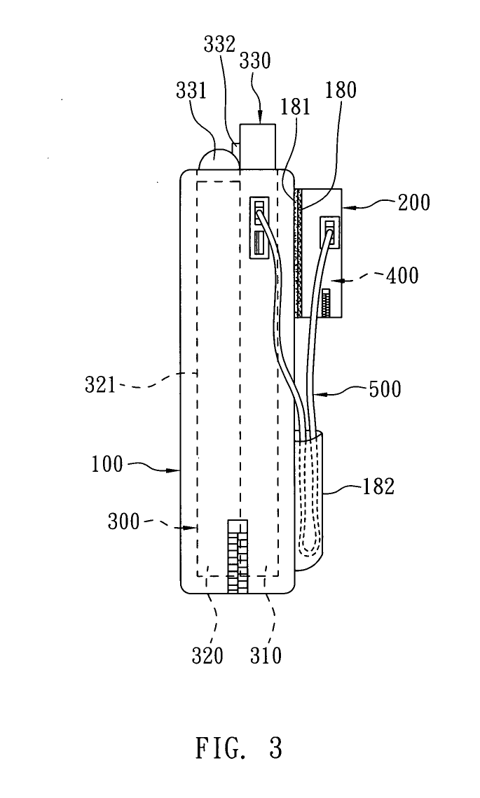

Refer to FIG. 1, FIG. 2 and FIG. 3. FIG. 1 illustrates a perspective view of a first embodiment in accordance with the present invention wherein the computer 300 is stored within the portable bag 10, and the radio frequency identification 400 is stored in the first container 200. FIG. 2 illustrates a rear view of the portable bag 10 in accordance with FIG. 1. FIG. 3 illustrates an assembly side view of the combination of the wireless computer apparatus and the portable bag.

The combination wireless computer apparatus and portable bag includes a portable bag 10 and a wireless computer module 20.

The portable bag 10 is provided to hold the wireless computer module 20 and includes a bag 100 and a first container 200. The bag 100 includes a compartment 110, an opening 120, a showing area 130, multiple side slots 140, 150, 160, and an aperture 170.

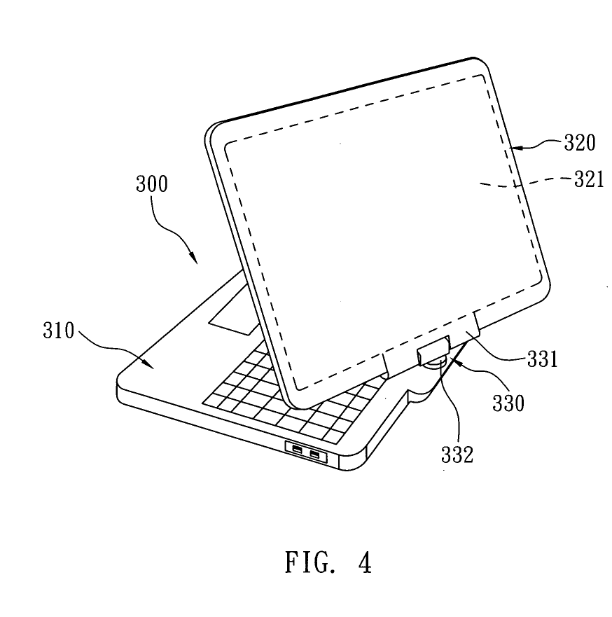

Refer to FIG. 4. The wireless computer module 20 includes a computer 300 and a radio frequency identification system (RFID) 400. The computer 300 has a body 310, an upper lid 320, and a joint unit 330.

The upper lid 320 is covered on the body 310 to shelter the keyboard. The joint unit 330 is connected between the body 310 and the upper lid 320, and has a first hinge 331 and a second hinge 332. The first hinge 331 provides a first orientation range whereby the upper lid 320 is capable of being lifted from the body 310, and the second hinge 332 provides a second orientation range whereby the upper lid 320 is capable of being rotated on the body 310 and the display 321 of the upper lid 320 is rotated form the first position facing the body 310 to the second position facing the showing area 130 of the bag 100 for reveal.

After the wireless computer module 20 is received in the compartment 110 of the bag 100 through the opening 120 with the zipper, the display 321 is exposed through the showing area 130, and the joint unit 330 is exposed through the side slot 140. In addition, the transmission interface of the computer 300 is exposed through the side slot 150 whereby the information transmission would be done with a transmission wire 500 connected between the computer 300 and the radio frequency identification 400. The side slot 160 corresponds to the heat sink hole of the computer 300 for heat dissipation, and exposes the touch pen 340 detachably embedded in the computer 300 for being drawn out of the bag 100.

Furthermore, first container 200 comprises a hook portion 180, and the bag 100 of the portable bag 10 includes a loop portion 181, a second container 182, and a wrist wrap 183 wherein the hook portion 180 is placed on the back of the first container 200 and the loop portion 181 is placed on the back of the bag 100. The second container 182 is fastened on the back of the first container 200 to store the transmission wire 500. The wrist wrap 183 is located on the back of the bag 100. The first container 200 holding the radio frequency identification 400 is detachably attached on the bag 100 through the bond between the hook portion 180 and the loop portion 181.

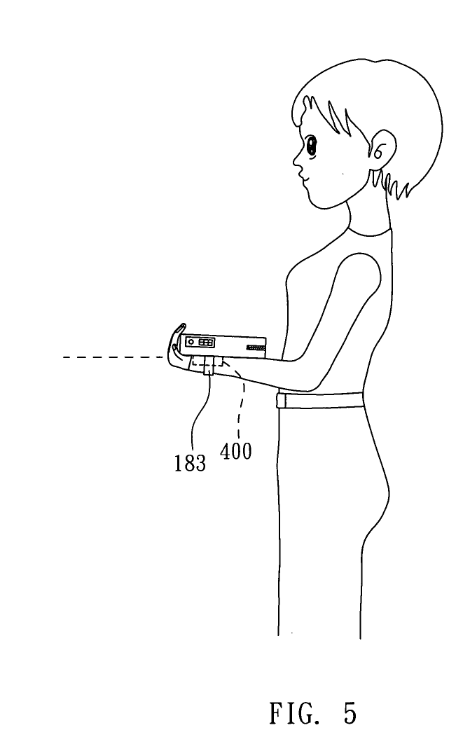

Hence, the computer 300 is stored within the portable bag 10, and is kept from damaging by external force to protect itself. During the inventory by using the combination wireless computer apparatus and portable bag (refer to FIG. 5), the radio frequency identification 400 stored in the first container 200 is fastened on the bag 100 such that the user can grip the touch pen to manipulate the computer 300 held in the other hand without the inconvenience caused by carrying the radio frequency identification 400 with another hand. Therefore, the stock can be detected by the radio frequency identification 400 is carried with the computer 300, and the user can manipulate the computer 300 simultaneously to facilitate the item classification and raise the working efficiency. Moreover, the computer 300 can be tied with the hand through the bond between the hook portion 1831 on the wrist wrap 183 and the loop portion 1832 on the bag 100 to prevent the computer 300 from falling down.

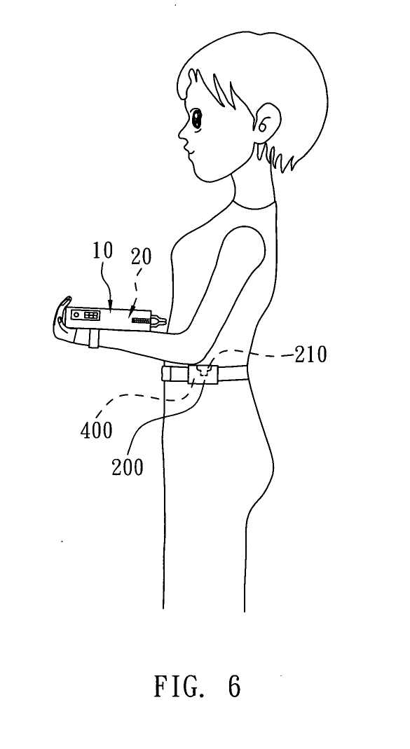

Refer to FIG. 6 which illustrates an operational perspective view of a second embodiment in accordance with the present invention. In the second embodiment, the first container 200 includes a hanger 210 which can be hung on a user's waist belt to provide the same effect as the first embodiment in FIG. 5.

Although the wireless computer module 20 in the above embodiments is illustrated with notebooks, the wireless computer module can be replaced by personal digital assistant (PDA) or the like electronic equipments for warehouse management.

As embodied and broadly described herein, the computer 300 and the radio frequency identification 400 are respectively protected by the bag 100 and the first container 200 to prevent from being damaged by external force. In addition, the first container 200 holding the radio frequency identification 400 is detachably attached on the bag 100 such that the user can take inventory without carrying the radio frequency identification 400 on another hand to solve the inconvenience problem and raise working efficiency.

Although the present invention has been described in considerable detail with reference to certain preferred embodiments thereof, other embodiments are possible. Therefore, the spirit and scope of the appended claims should not be limited to the description of the preferred embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A combination wireless computer apparatus and portable bag, and the combination comprising:
a wireless computer module comprising a computer and a radio frequency identification system wherein the computer comprises a body and a display, and the radio frequency identification system is electrically connected with the body; and
a portable bag holding the wireless computer module, and comprising a bag and a first container demountably mounted to the bag wherein the bag comprises a compartment, an opening, a showing area and a plurality of side slots;
whereby the wireless computer module is received in the compartment of the bag through the opening, the display is shown through the showing area, and the radio frequency identification system is held in the first container.

2. The combination wireless computer apparatus and portable bag of claim 1, wherein the computer comprises an upper lid covering the body and a joint unit connected between the body and the upped lid wherein the joint unit comprises a first hinge providing a first orientation range for the upper lid being capable of lifting from the body, and a second hinge providing a second orientation range for the display of the upper lid being capable of rotating on the body.

3. The combination wireless computer apparatus and portable bag of claim 2, wherein the joint unit is exposed through one of the side slots.

4. The combination wireless computer apparatus and portable bag of claim 1, wherein the first container comprises a hook portion placed on a back of the first container and the bag comprises a loop portion placed on a back of the bag.

5. The combination wireless computer apparatus and portable bag of claim 1, wherein the first container comprises a hanger.

6. The combination wireless computer apparatus and portable bag of claim 1, wherein the wireless computer module comprises a transmission interface connected with the radio frequency identification system by a transmission wire through one of the side slots of the bag.

7. The combination wireless computer apparatus and portable bag of claim 6, wherein the portable bag comprises a second container holding the transmission wire.
